(19) United States
(12) Patent Application Publication
(10) Pub. No.: US 2019/0257378 A1
(43) Pub. Date: Aug. 22, 2019

(54) METHOD OF OPERATING AND CONTROLLING A BRAKE

(71) Applicant: AKEBONO BRAKE INDUSTRY CO., LTD, Tokyo (JP)

(72) Inventors: Takashi Masuda, Novi, MI (US); Hideki Kakizaki, Kazo-City (JP)

(21) Appl. No.: 15/901,138

(22) Filed: Feb. 21, 2018

(51) Int. Cl. F16D 65/18; B60T 17/22; B60T 7/10; B60T 13/74

(52) U.S. Cl. CPC F16D 65/183; B60T 17/22; F16D 2121/24; B60T 13/741; B60T 7/107

(57) ABSTRACT

A method of controlling a brake system includes steps of: determining a motor time constant, estimating a motor temperature of a motor based on the motor time constant; estimating a position of component of the brake system; estimating a clamping force based on the estimated position of the component; comparing the estimated clamping force to a threshold predetermined clamping force value to determine if a sufficient clamping force has been created.

### FIELD

These teachings relate to a method of operating and controlling a brake.

### BACKGROUND

A brake system includes at least one braking component that is moved against a moving component to create a clamping force. The clamping force may be used to slow, stop, or prevent movement of the moving component. In vehicular applications, the braking component may be a brake pad or brake shoe, and the moving component may be a brake rotor or a brake drum.

Some brake systems are electromechanical systems that include a brake motor and/or actuator for moving the braking component against the moving component to create the clamping force. Some systems use a position sensor to provide information relating to an angular position of an output of the brake motor and/or a position of an actuator or braking component to determine when contact is made between the braking component and the moving component and/or when, or if, the clamping force has been created.

To reduce cost, packaging space, and weight, and to comply with vehicle guidelines and recommendations, it may be desirable to have a brake system that does not require or include a position sensor. For example, it may be desirable to have a brake system and/or a method for accurately determining if and/or when contact is made between the braking component and the moving component and/or if and/or when a clamping force has been created without relying on a position sensor. Some examples of controlling brake system are disclosed in U.S. Patent Application Numbers US 2015/0066324 and US 2016/0025169, both of which are expressly incorporated by reference herein for all purposes.

### SUMMARY

These teachings provide a brake system. These teachings also provide a method or control logic for operating and/or controlling a brake system.

The method or control logic according to the teachings herein may be used to accurately and precisely estimate and/or determine when contact is made between the braking component and the moving component and/or that the clamping force has been created. These teachings provide a brake system and/or a method for accurately and precisely estimating and/or determining when contact is made between the braking component and the moving component and/or that the clamping force has been created without using a position sensor, such as a hall effect sensor, for example.

The method according to these teachings may be incorporated into a control logic, computer, software, memory, or other storage medium that is located in a brake system, a computer, a vehicle memory or computer, or a combination thereof. The method, control logic, computer, software, memory, or other storage medium may be incorporated into a vehicle computer or module, such as a vehicle's electronic control unit (ECU). The method or control logic according to the teachings herein may be loaded or stored on a computer or storage medium of a vehicle for operating a vehicle's brake system.

The method according to the teachings herein may be incorporated into or part of a vehicle brake system, parking brake system, or both. Accordingly, the braking component as used herein may be a brake pad or brake shoe, and the moving component may be a brake rotor or brake drum.

A method of controlling a brake system includes steps of: determining a motor time constant; estimating a motor temperature of a motor based on the motor time constant; estimating a position of component of the brake system; estimating a clamping force based on the estimated position of the component; comparing the estimated clamping force to a threshold predetermined clamping force value to determine if a sufficient clamping force has been created.

### BRIEF DESCRIPTION OF THE DRAWINGS

FIG. 1 is a perspective cross-sectional view of a brake system that is a disc brake system.

FIG. 2 is a perspective view of another brake system that is a drum brake system.

FIG. 3 is a flow chart illustrating a method of operating or controlling the brake system of FIG. 1 and/or FIG. 2.

FIG. 4 is a current vs. time graph.

FIG. 5 is a motor time constant vs. motor temperature graph.

FIG. 6 is a flow chart illustrating steps 116, 118, and 120 of the method of FIG. 3.

FIG. 7 is a graph illustrating estimated clamping force vs. estimated position.

FIG. 8 is a graph illustrating clamping force target force shift based on estimated motor temperature.

### DETAILED DESCRIPTION

The present teachings make use of a brake system. The brake system may be any device, system, and/or assembly that may create a clamping force. For example, the brake system may be a disc brake system, a drum brake system, a drum-in-hat brake system, or a combination thereof.

The clamping force may be created during a standard application of the service brake. The clamping force may be any force that, when coupled with a brake pad or a brake shoe coefficient of friction, slows, stops, and/or prevents movement or rotation of a brake rotor or a brake drum, respectively; slows, stops, and/or prevents movement of a vehicle; or a combination thereof.

The disc brake system may include a brake rotor, one or more brake pads, and a brake caliper supporting one or more brake pistons and the parking brake system, which may include a motor gear unit (MGU) and an actuator assembly. The drum-in-hat brake system may include a drum brake, one or more brake shoes, and a backing plate supporting the parking brake system, which may include a motor and an actuator assembly.

A brake rotor may cooperate with the components of the disc brake system, the components of the parking brake system, or both to create a clamping force during a standard brake apply; a parking brake apply; or both. The brake rotor may rotate with a wheel and axle of a vehicle when the vehicle is in motion. The brake rotor may include an inboard side and an opposing outboard side. To create the clamping force, the friction material of the one or more brake pads may be moved or pushed against at least one of the sides of the brake rotor. After the one or more brake pads are moved or pushed against the brake rotor, the brake rotor may be restricted from rotating, and, accordingly, the vehicle may be slowed, stopped, and/or restricted from moving. After the friction material of the one or more brake pads is moved away from the brake rotor, the brake rotor and, accordingly, the vehicle can once again move.

The brake caliper may function to support one or more the components of the brake system, one or more the components of the parking brake system, or both. The brake caliper may be connected to a knuckle or a support structure of a vehicle. The brake caliper may support one or more brake pistons, one or more brake pads, and one or more actuator assemblies.

The one or more brake pistons may function to move a brake pad, or a corresponding end of brake pad, towards a side of the brake rotor to create the clamping force. During a parking brake apply, and/or during release of the parking brake apply, the brake piston may be moved by a corresponding actuator assembly. The brake piston may include a closed end selectively engaging the pressure plate of an inboard brake pad and an open end defining an opening into a piston pocket. The piston pocket may function to receive at least a portion of an actuator assembly. The piston pocket may be a cup or recess formed into one end of the brake piston.

The actuator assembly may function to move the one or more brake pistons, the one or more brake pads, or both towards the brake rotor to create the clamping force. The actuator assembly may function to move the one or more brake pistons, the one or more brake pads, or both away from the brake rotor to release the clamping force. In a disc brake system, the actuator assembly may comprise a motor gear unit (MGU), a spindle, and a nut. In a drum-in-hat brake system, the actuator assembly may include a motor, a spindle, a nut, and a brake cable.

The motor gear unit (MGU) may function to generate and/or transfer a force or torque that is suitable for creating and/or releasing the clamping force. During application of the parking brake system, the MGU may function to generate a force or torque that is sufficient to move the one or more corresponding spindle and nuts, the one or more brake pistons, the one or more brake pads, or a combination thereof towards the brake rotor. During release of the parking brake, the MGU may function to generate a force or torque that is sufficient to move the one or more corresponding spindle and nuts, the one or more brake pistons, or both away from the one or more brake pads so that the brake pads move away from the brake rotor.

The MGU may be any device or combination of device that may function to perform one or more of the aforementioned functions. The MGU may include a motor. The motor may be any suitable motor. For example, the motor may be a DC motor, a series-wound motor, a shunt wound motor, a compound wound motor, a separately exited motor, a servomotor, or a permanent magnet motor. The MGU may include or may be in communication with one or more gears or gear trains that may function to transfer, increase, and/or decrease an output force or torque generated by the motor. At least a portion of the MGU may be contained within a housing. The housing may be integrally formed with the brake caliper; removably attached to the brake caliper; permanently attached to the brake caliper; or attached in any suitable way to the vehicle. The one or more gears or gear trains may be located within the housing or located outside of the housing. The one or more gears or gear trains may be located intermediate an output shaft of the motor or MGU and one or more spindles.

The one or more spindles may function to transfer torque from the motor, the MGU, one or more gears or gear trains, or a combination thereof into a linear force to move a corresponding nut, a corresponding brake piston, and/or a corresponding brake pad towards the brake rotor to create the clamping force. The one or more spindles may function to transfer torque from the motor, the MGU, or both into a linear force to move a corresponding nut, a corresponding brake piston, and/or a corresponding brake pad away from the brake rotor to release the clamping force. Each of the one or more spindles may have an input portion that is in communication with an output of the motor, the MGU, or both, and an output portion that is in communication with a corresponding nut. The input portion may receive motor torque from the motor, the MGU, or both, which may cause the spindle to rotate. The input portion may include any suitable connection for connecting with the motor, the MGU, or both. For example, the connection may include a threaded engagement, a friction engagement, an interference engagement, and/or the input portion may be coupled to the motor gear unit with one or more mechanical fasteners. Preferably, the connection is keyed (i.e., may include teeth, gears, notches, grooves, etc.). The output portion of the one or more spindles may include any suitable connection for connecting with the nut. Preferably, the output portion may engage a corresponding nut with a threaded engagement; however, a sliding engagement, an interference engagement, a permanent engagement, a removable engagement, a keyed engagement, or any other suitable engagement may be used.

Each of the one or more nuts may function to move a corresponding brake piston. That is, each of the one or more nuts may be in received in a piston pocket of a corresponding brake piston. The one or more nuts may transmit torque received from a corresponding spindle into a linear force to axially move the brake piston along a piston axis towards and/or away from a bottom surface of the piston pocket. In other words, rotation of a corresponding spindle may cause the corresponding nut to move axially along a nut axis. For example, during a parking brake apply, the spindle may rotate in a first or apply direction, which may cause the nut to move in a first or apply direction towards the bottom surface of the piston pocket. Further rotation of the spindle may cause the nut to engage the bottom surface of the piston pocket and then move the brake piston and the brake pad until the friction material of the brake pad eventually engages the brake rotor. During release of the parking brake apply, the spindle may rotate in a second or release direction, which may cause the nut to move in a second or release direction away from the bottom surface of the piston pocket so that the brake piston and the brake pad can move away from and disengage the brake rotor.

The drum-in-hat brake system may include a drum brake, and a backing plate supporting one or more brake shoes and the parking brake system, which may include a motor and an actuator assembly.

The brake drum may cooperate with the components of the drum-in-hat brake system, the components of the parking brake system, or both to create a clamping force during a brake apply, a parking brake apply, or both. The brake drum may rotate with a wheel and axle of a vehicle when the vehicle is in motion. After the one or more brake shoes are pushed radially outward and engage an inner surface of the brake, the brake drum may be restricted from rotating, and, accordingly, the vehicle may be slowed, stopped, and/or restricted from moving. After the one or more brake shoes are moved away from the brake drum, the brake drum, and, accordingly, the vehicle can once again move.

The one or more brake shoes may function to create the clamping force. The one or more brake pads may include a pressure plate and a friction material. The pressure plate of the one or more brake shoes may be in communication with the one or more expanding mechanisms. During a brake apply, an actuator assembly may move the one or more expanding mechanisms, which may cause the one or more brake shoes, or ends of the one or more brake shoes to move radially outward against the inner surface of the brake drum to create the clamping force.

The actuator assembly may function to move one or more brake shoes towards or away from the inner surface of the brake drum. That is, during a brake apply, the actuator assembly may move the one or more expanding mechanism, which may cause the brake shoes to move radially outward and against the brake drum to create the clamping force. During release of the brake, the actuator assembly may move the one or more expanding mechanisms, which may cause the brake shoes to move away from, and out of engagement with, the brake rotor and release the clamping force. The actuator assembly may be contained within a housing and may generally include therein a motor, a spindle, and a nut. The housing may include a boot protecting at least a portion of the brake cable and the spindle. The boot may be made of a generally flexible material.

The actuator may be of the type disclose in commonly owned U.S. patent application Ser. No. 14/750,488 filed on Jun. 25, 2015, which is hereby incorporated by reference herein for all purposes. The actuator may be of the type disclose in commonly owned U.S. patent application Ser. No. 15/248,134 filed on Aug. 26, 2016, which is hereby incorporated by reference herein for all purposes.

The brake cable may function to move the one or more brake shoes to create or release the clamping force. The brake cable may be moved when the spindle is moved by the nut and motor. The brake cable may be pulled, which, via a connecting portion, may move an expanding mechanism or parking brake lever in communication with one or more brake shoes so that the one or more brake shoes engage the inner surface of the brake drum to create the clamping force. Once the clamping force is established, the brake cable may be in tension. Accordingly, moving the spindle in the second or release direction may reduce the tension in the brake cable, thereby allowing the expanding mechanism to move so that the one or more brake shoes can disengage the inner surface of the brake drum and release the clamping force. The brake cable may include a connecting portion for engaging the parking brake lever, one or more brake shoes, the like, or a combination thereof. The connecting portion may be any feature that may engage the parking brake lever, one or more brake shoes, the like, or a combination thereof. For example, the connecting portion may be a joint jaw, a hook, a cable crimp, etc.

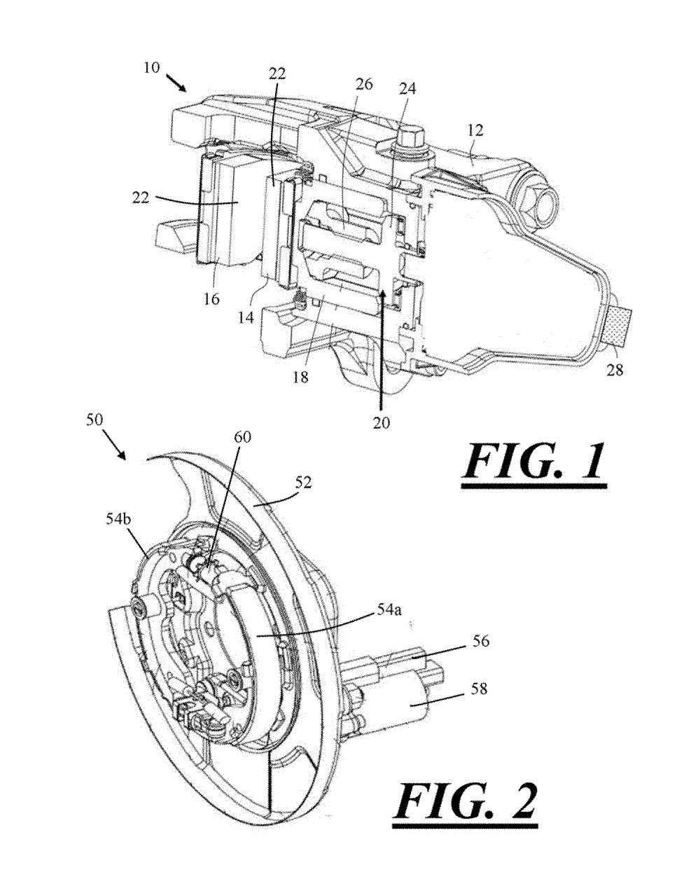

FIG. 1 is a perspective, cross-sectional view of a brake system 10 that is a disc brake system. The brake system 10 includes brake caliper 12 that is adapted to support opposing braking components 14, 16 that are inner and outer brake pads, respectively. The brake caliper 12 is also adapted to support a brake piston 18 and an actuator assembly 20. Each of the brake pads 14, 16 include a friction material 22 that is arranged to face a side of the braking component (i.e., a brake rotor). The actuator assembly 20 comprises a spindle 24, a nut 26, and a brake motor 28.

The brake system 10 may be adapted to create clamping force. The clamping force may be used to slow, stop, or prevent movement of the moving component (i.e., a brake rotor). The clamping force may be used during application of the service brake, parking brake, or both to slow, stop, or prevent movement of the moving component. In vehicular applications, the moving component may be a brake rotor, and the clamping force may function to slow, stop, or prevent movement of the brake rotor and thus a road wheel and ultimately the vehicle.

To create clamping force, the brake motor 28 is adapted to generate torque that is adapted to move or rotate the spindle 24 in an apply direction. A gear train may be located between an output of the brake motor 28 and the spindle 24 so that the torque generated by the brake motor 28 is increased or decreased before the torque is communicated to the spindle 24. Rotation of the spindle 24 in the apply direction causes the nut 26 to move axially in an apply direction towards a bottom surface of a piston pocket in the brake piston 18. After the nut 26 contacts the bottom surface of the piston pocket, further rotation of the spindle 24 causes the nut 26 to axially move and push the brake piston 18 and thus the brake pad 14 against the brake rotor. At the same time, one or more brake caliper fingers pull the outboard brake pad 16 towards and against an opposing side of the brake rotor until a sufficient clamping force is established.

To release the clamping force, the brake motor 28 is adapted to generate a torque that causes the spindle 24 to move or rotate in an opposing, release direction. Rotation of the spindle 24 in the release direction causes the nut 26 to move axially in an opposing release direction away from the bottom surface of the brake piston 18 thereby allowing the brake piston 18 and the brake pads 14, 16 to move away from the brake rotor thus releasing the clamping force. After the clamping force has been reduced or released, the moving component or brake rotor may once again move. In vehicular applications, this may mean that the road wheel and thus the vehicle can once again move.

FIG. 2 is a perspective, cross-sectional view of a brake system 50 that is a drum-in-hat brake system. The brake system 50 includes a backing plate 52 that is adapted to support a pair of braking components 54a, 54b that are brake shoes. The brake system 50 includes an actuator assembly 56 and a brake motor 58. An expanding mechanism 60 is located in between the brake shoes 54a, 54b.

The brake system 50 may be adapted to create clamping force. The clamping force may be used to slow, stop, or prevent movement of the moving component or brake rotor. The clamping force may be used during application of the service brake, parking brake, or both.

To create clamping force in the brake system 50 of FIG. 2, the brake motor 58 is adapted to generate motor torque that causes a brake cable to pull the expanding mechanism 60, which causes one or both of the brake shoes 54a, 54b to move and engage an inner surface of a brake drum to create the clamping force.

To release the clamping force in the system 50 of FIG. 2, the brake motor 58 is adapted to generate torque that causes one or both of the brake shoes 54a, 54b to move and disengage the inner surface of a brake drum and release the clamping force. After the clamping force is reduced or released, the moving component or brake drum may once again move. In vehicular applications, this may mean that the road wheel and thus the vehicle may once again be moved.

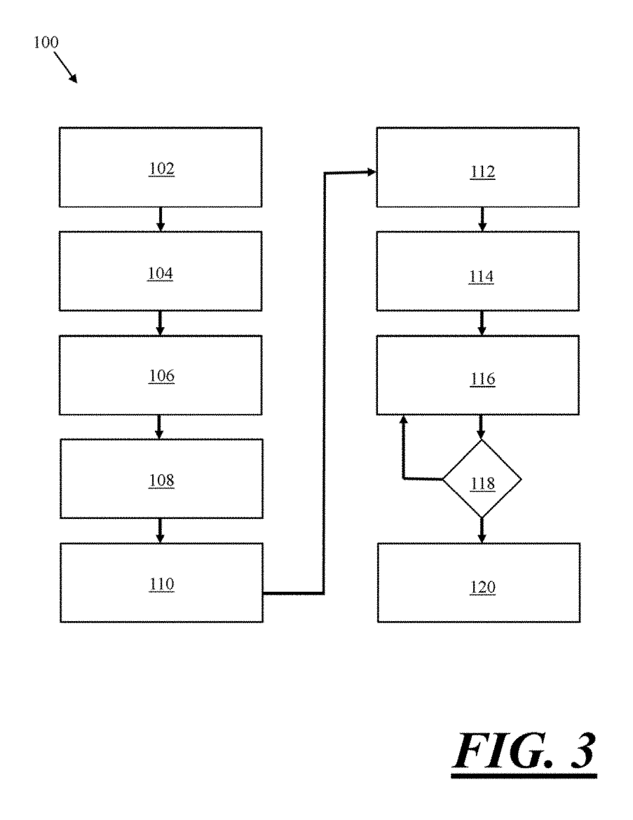

Referring to FIG. 3, creating the clamping force using either or both brake systems 10, 50 of FIG. 1 or 2 can be operated, controlled, or monitored according to a method 100. The method 100 may be used during a brake apply, a parking brake apply, or both. The method 100 may be used to determine if and/or when a sufficient clamping force has been generated or created. Advantageously, the method 100 can be used to determine if and/or when a sufficient clamping force has been generated or created without requiring use of a position sensor or hall effect sensor.

The method 100 may include a number of discrete steps. These steps can be performed in virtually any order. One of more of the steps may be omitted, repeated, and/or combined with other steps disclosed herein.

The method 100 includes a step 102 of applying the brake. The applying step 102 may begin or may be initiated by a deliberate act by a user. For example, the applying step 102 may occur during or after a user depresses, engages, or otherwise moves or displaces a pedal, a lever, or a button.

Additionally, or alternatively, the applying step 102 may begin automatically. For example, the applying step 102 may be automatically initiated when or after the vehicle is stopped or not moving for a predetermined amount of time; put into a park gear; turned OFF; a is door opened; a seat belt unbuckled; or a combination thereof.

At or during the applying step 102, power is transmitted to the brake motor 28, 58. The power may be produced, provided, and/or transmitted to the brake motor 28, 58 by or from a computer, electronic stability controller (ESC), and/or the vehicle battery. The power causes the brake motor 28, 58 to turn ON or be energized.

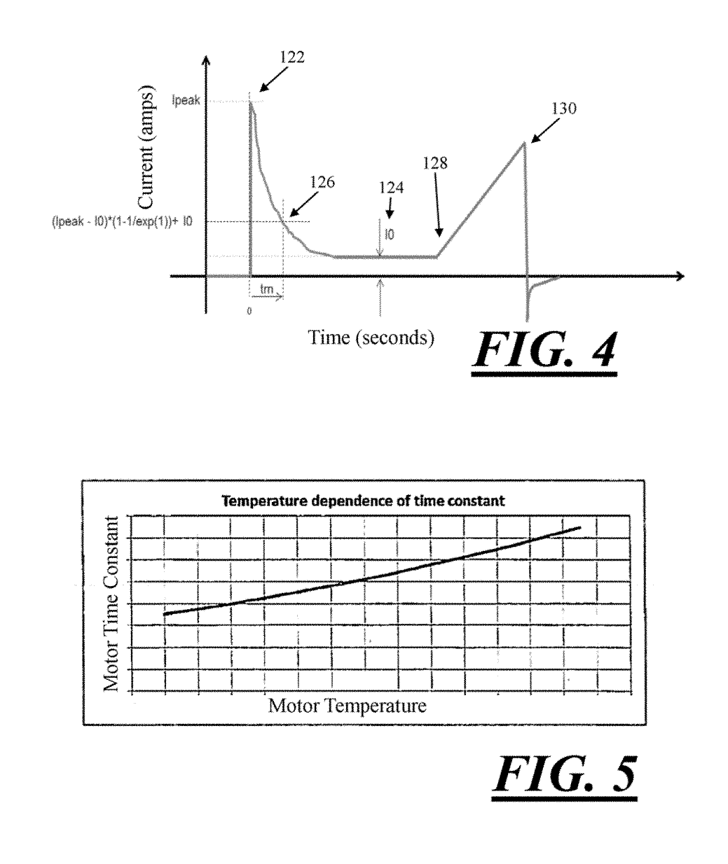

At or during step 104, an inrush current is determined or measured. Inrush current, which may also be referred to as input surge current, or switch-on current, is the maximum, instantaneous current drawn by the motor 28, 58 when/after the motor 28, 58 is energized or first turned ON at step 102. This determined or measured inrush current value is stored in memory. In FIG. 4, inrush current is identified as I_{NA} at 122.

At or during step 104, the load or torque acting on the motor 28, 58 may be zero. This means that there is little or no load or resistance acting on an output of the motor 28, 58. This may mean that while the motor 28, 58 is drawing current, an output shaft or output gear of the motor 28, 58 is not rotating or moving. This may mean that the motor 28, 58 is drawing current, and an output shaft or output gear of the motor 28, 58 is rotating, but a clamping force is not yet being created or generated. Stated another way, while the motor 28, 58 may be drawing current from the power source in step 104, the braking components (i.e., brake pads or brake shoes) are not yet in contact with or pressing against the moving component (i.e., brake rotor or brake drum).

At or during step 106, a free running current I₀ and a free running voltage V₀ is determined or measured. The free running current I₀ and the free running voltage V₀ are determined or measured after the inrush current Iₚₑₐₖ is determined or measured at or during step 104 (point 122 at FIG. 4).

The free running current I₀ and the free running voltage V₀ are determined or measured during a no-load or free condition, which is an interval or period of time before the braking component (i.e., brake pad or brake shoe) contact the moving component (i.e., brake rotor or brake drum). Stated another way, the free running current I₀ and the free running voltage V₀ are measured or determined during a time period after the inrush current Iₚₑₐₖ is determined or measured but before the braking components contacting the moving component and the clamping force begins to be created or generated. Once determined or measured, the free running current I₀ and the free running voltage V₀ are stored in memory. Referring to FIG. 4, the free running current I₀ is illustrated at 124. After the free running current I₀ and the free running voltage V₀ are determined, the continued supply of current I and voltage V to the brake motor 28, 58 is monitored throughout the method 100 and also stored in memory.

At or during step 108, motor time constant Tₘ is determined or calculated. Motor time constant Tₘ may be defined as the time required for the brake motor 28, 58 to reach 63.2% of its maximum rated speed during the no-load or free running condition discussed above at step 106. The maximum rated speed of the brake motor 28, 58 may be a known value that is typically provided by the brake motor supplier or manufacturer.

The motor time constant Tₘ is determined or calculated using the determined or measured values of free running current I₀ and free running voltage V₀ from step 106 and the measured or determined inrush current Iₚₑₐₖ from step 104. The motor time constant Tₘ is the time from the start of actuation of the brake motor 28, 58 to when the brake motor 28, 58 draws a particular current threshold. The current threshold can be determined or calculated according to the following formula: Iₚₑₐₖ*(1−0.632). Stated another way, the current threshold is approximately 36.8% of Iₚₑₐₖ, which is the inrush current determined or measured at or during step 104.

Alternatively, referring to FIG. 4, the motor time constant Tₘ is identified at 126, and may be defined as the time between the inrush current Iₚₑₐₖ 122 and when the motor current I is measured or determined to be at or below 36.79% of the inrush current 122 Iₚₑₐₖ that was determined or measured at step 104.

At or during step 110, motor temperature is estimated using the motor time constant Tₘ determined at step 108. Referring to FIG. 5, motor time constant Tₘ has a positive and a generally linear relationship with motor temperature. Therefore, after the motor time constant Tₘ is determined in step 108, the motor temperature can be accurately estimated using FIG. 5. FIG. 5 may be configured as a look up table that is stored in the memory.

At or during step 112, values of motor resistance Rₐ, motor torque constant Kₜ, and viscosity v are determined based on the estimated motor temperature from step 110 and/or based on the motor time constant Tₘ from step 108.

Motor resistance Rₐ has a generally positive correlation with motor temperature, and is calculated using the formula: Rₐ=Rₐ0*[1+α*(T_{c}−25)], where T_{c} is the estimated motor temperature from step 110, and a relates the change in motor resistance Rₐ to the estimated motor temperature Tc. α is positive value. Rₐ0 is motor resistance Rₐ at room temperature, 25° C.

Motor torque constant Kₜ has a generally negative correlation with motor temperature, and can be calculated using the formula: Kₜ=Kₜ0*[(1+β*(T_{c}−25)], where T_{c} is the estimated motor temperature from step 110, and β relates the change in motor torque Kₜ to the estimated motor temperature Tc. β may have a negative value. Kₜ0 is the motor torque constant Tₘ from step 108 at room temperature, 25° C.

Viscosity v is based on or related to the estimated motor temperature, and can be determined using a look-up table stored in memory using the estimated motor temperature from step 110 and/or motor time constant Tₘ from step 108.

After motor resistance Rₐ, motor torque constant Kₜ, and Viscosity v are determined, the observer parameter is determined. The observer parameter may be adapted to estimate displacement, or a position, or an angular or rotational position of a component of the brake system of FIG. 1 or FIG. 2. For example, the component of the brake system may be an output of the motor 28, 58 (FIGS. 1 and 2); the spindle 24 (FIG. 1); the nut 26; the actuator assembly 56 (FIG. 2); the expanding mechanism 60 (FIG. 2), or a combination thereof. The observer parameter is discussed in greater detail in Applicant's U.S. application Ser. No. 15/290,716 filed on Oct. 11, 2016, which claims priority to U.S. 62/241,340 filed on Oct. 14, 2015, both of which are expressly incorporated by reference herein for all purposes. The observer parameter is identified as the linear time variant observer (LTV) 300 in the aforementioned application.

The observer parameter may be determined or calculated according to the following equations:

$$[ \begin{matrix}\ddot{\hat{θ}} ( t ) \\ \dot{\hat{I}} ( t )\end{matrix} ] = [ \begin{matrix}- \frac{nu}{J} & \frac{Kt}{J} \\ - \frac{Kb}{La} & - \frac{Ra}{La}\end{matrix} ] [ \begin{matrix}\dot{\hat{θ}} ( t ) \\ \hat{I} ( t )\end{matrix} ] + [ \begin{matrix}0 & 1 \\ \frac{1}{La} & 0\end{matrix} ] [ \begin{matrix}V ( t ) \\ \hat{τ} ( t ) \hat{θ} ( t )\end{matrix} ]$$

$${A}^{′} = [ \begin{matrix}- \frac{nu}{J} & \frac{Kt}{J} \\ - \frac{Kb}{La} & - \frac{Ra}{La}\end{matrix} ] , {B}^{′} = [ \begin{matrix}0 & 1 \\ \frac{1}{La} & 0\end{matrix} ] , {C}^{′} = [ 0 \; 1 ]$$

$$\hat{x} [ k + 1 ] = {e}^{A ′ T} \hat{x} [ k ] + {A}^{′ - 1} ( {e}^{{A}^{′} T} - I ) {B}^{′} u [ k ]$$

The values of motor resistance Rₐ, motor torque constant Kₜ, and viscosity v that were determined at or during step 112 are used to determine the continuous time state/system matrix A′ and input matrix B′ above. In the aforementioned equations, nu represents viscosity v; Kₜ represents motor torque constant; and Rₐ represents motor resistance. Again, nu, Kₜ, and Rₐ were determined above at or during step 112.

To improve the computational efficiency, the discrete representation Ad and Bd is calculated based on a discrete sampling time T using the formula below where I represents the unit identity matrix.

$$Here , Ad ≡ {e}^{{A }^{′} T} Bd ≡ {A}^{′ - 1} ( {e}^{{A}^{′} T} - I ) {B}^{′}$$

$$\hat{x} [ k + 1 ] = Ad \hat{x} [ k ] + Bdu [ k ] \\ [ \begin{matrix}\hat{\dot{θ}} [ k + 1 ] \\ \hat{I} [ k + 1 ]\end{matrix} ] = ( \begin{matrix}Ad 11 & Ad 12 \\ Ad 21 & Ad 22\end{matrix} ) [ \begin{matrix}\dot{\hat{θ}} [ k ] \\ \hat{I} [ k ]\end{matrix} ] + ( \begin{matrix}Bd 11 & Bd 12 \\ Bd 21 & Bd 22\end{matrix} ) [ \begin{matrix}V [ k ] \\ \hat{τ} \hat{θ} [ k ]\end{matrix} ] = [ \begin{matrix}{Ad}_{11} * \dot{\hat{θ}} [ k ] + {Ad}_{12} * \hat{I} [ k ] + {Bd}_{11} * V [ k ] + {Bd}_{12} * \hat{τ} \hat{θ} [ k ] \\ {Ad}_{21} * \dot{\hat{θ}} [ k ] + {Ad}_{22} * \hat{I} [ k ] + {Bd}_{21} * V [ k ] + {Bd}_{22} * \hat{τ} \hat{θ} [ k ]\end{matrix} ]$$

After step 112, the method may proceed to either step 114 or directly to step 116. That is, step 114 described below may be optional or omitted.

At or during step 114, knee point is detected. The knee point is also discussed in greater detail in Applicant's U.S. application Ser. No. 15/290,716 filed on Oct. 11, 2016, which claims priority to U.S. 62/241,340 filed on Oct. 14, 2015, both of which are incorporated by reference herein for all purposes.

During application of the brake or generation of the clamping force, the knee point may be when the braking component (i.e., brake pad or brake shoe) makes contact with the moving component (i.e., brake rotor or brake drum). Stated another way, the knee point may be when there is zero clearance or gap defined between the braking component and the moving component.

During application of the brake or generation of the clamping force, the knee point may be calculated or detected when a change in the current I divided by a change in a displacement or a position or an angular or rotational position of a component of the brake system (FIG. 1 or FIG. 2) is greater than or equal to a threshold, predetermined value. Again, the component of the brake system may be an output of the motor 28, 58 (FIGS. 1 and 2); the brake spindle 24 (FIG. 1); the nut 26; the actuator assembly 56 (FIG. 2); the expanding mechanism 60 (FIG. 2), or a combination thereof. Again, the change in a displacement or a position or an angular or rotational position of the component of the brake system of FIG. 1 or 2 is estimated from the observer parameter determination discussed at step 112 above.

Knee point is illustrated in FIG. 4 at 128, where the motor current is no longer free running I₀, but instead beings to change or increase. That is, at the knee point when the braking component makes contacting with the moving component, the brake motor draws additional current I to continue to move the braking component against the moving component to create the clamping force.

After the knee point is detected or determined, estimated position 8 is forced or reset to zero. The “estimated position \hat{θ}” may refer to the estimated angular position or rotational position of the component of the brake system of FIGS. 1 and/or 2, which may be an output of the motor 28, 58; the spindle 24; the nut 26; the actuator assembly 56; the expanding mechanism 60′, or a combination thereof. Then, as the brake motor continues to draw current I, the angular position or rotational position of an output of the motor 28, 58; the position of the spindle 24; the position of the nut 26; the position of the actuator assembly 56; the position of the expanding mechanism 60′, or a combination thereof changes.

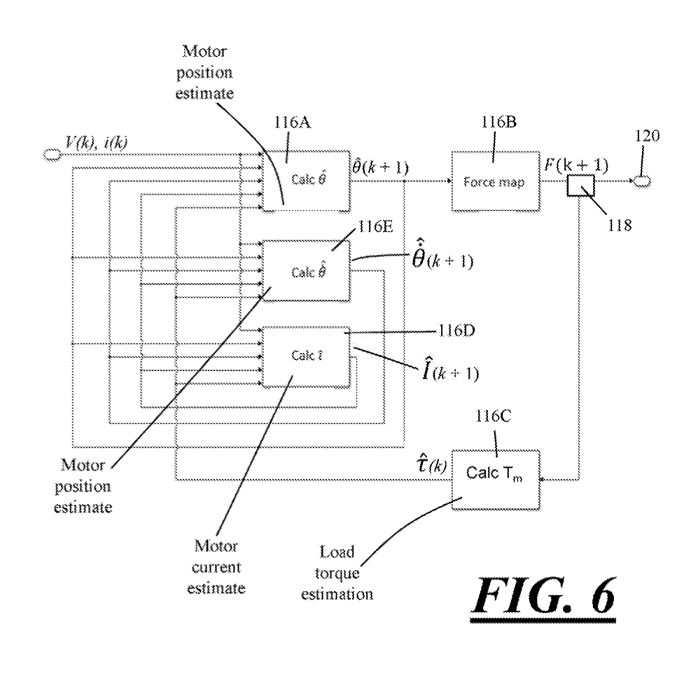

After step 112 or step 114, the method proceeds to Step 116. Referring to FIG. 6, step 116 comprises a plurality of sub steps 116A, 116B, 116C, 116D, and 116E.

At or during sub step 116A, the estimated position \hat{θ} of the brake component is calculated or determined according to the following formula:

\hat{θ}[k+1]=\hat{θ}[k]+dT*\hat{\dot{θ}}[k]+Lₚ{I[k]−Î[k])}

In the above equation, the estimated position \hat{θ} of the brake component is continuously calculated/updated as will be discussed further below, which is the reason for the “(k+1)” designation after \hat{θ}, until the estimated clamping force (determined at sub step 116B below) is greater than or equal to a predetermined threshold clamping force value.

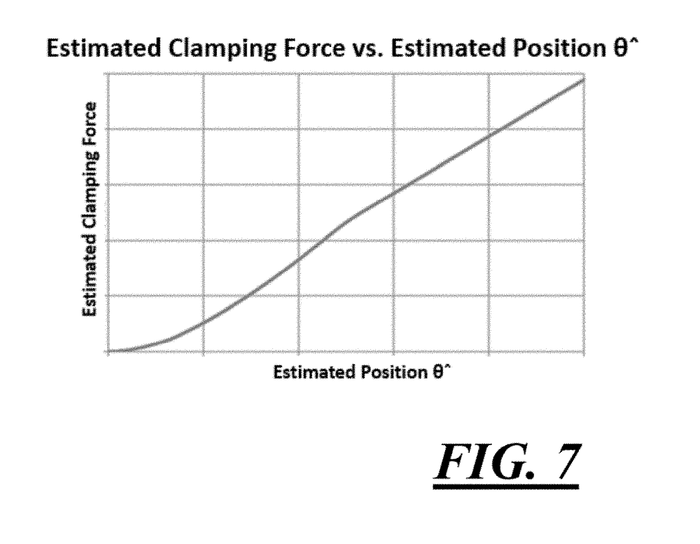

After the estimated position B of the brake component is calculated or determined at or during sub step 116A, an estimated clamping force is determined at or during sub step 116B with a lookup table, such as the one illustrated in FIG. 7. As shown, in FIG. 7, estimated clamping force and estimated position \hat{θ} have a positive and a generally positive, linear relationship.

The estimated clamping force is then compared to a predetermined threshold clamping force value at or during step 118. The predetermined threshold clamping force value is a force value that is determined to provide a sufficient clamping or holding force to restrict or prevent the moving component (i.e., the brake rotor or brake drum) from moving or rotating. The predetermined threshold clamping force value is the required clamping force that must be generated for the brake apply or the parking brake apply to be complete.

If the estimated clamping force is greater than or equal to the predetermined threshold clamping force value, then the required clamping force has been created, and the method proceeds to step 120 where the system is turned OFF and/or the method is complete. Referring back to FIG. 4, the desired clamping force is created at 130, and then current supply to the brake motor is discontinued and/or the brake motor is turned OFF and/or ceases drawing current.

If, however, the estimated clamping force is less than the predetermined threshold clamping force value, then the method proceeds to sub step 116C where a motor load torque Tₘ is determined. The load or torque Tₘ acting on the brake motor 28, 58 increases as the braking component (brake pad, brake shoe) is further moved against the moving component (brake rotor, brake drum) to increase the clamping force. As the motor load torque Tₘ increases, the brake motor 28, 58 continues to draw additional current I (i.e., between knee point 128 and end point 30 in FIG. 4). The motor load torque Tₘ is discussed throughout Applicant's U.S. application Ser. No. 15/290,716 filed on Oct. 11, 2016 and Applicant's application 62/241,340 filed on Oct. 14, 2015. In Applicant's U.S. application Ser. No. 15/290,716, motor load torque Tₘ is determined using EQ16 and EQ17.

After the motor load torque Tₘ is determined or calculated at or during sub step 116C, the motor load torque Tₘ is used to re-calculate or update the estimated position \hat{θ} of the brake component at or during sub step 116A. The method then proceeds back to sub step 116B where the updated estimated position \hat{θ} of the brake component is used to determine an estimated clamping force (i.e., FIG. 7), which is then compared to the threshold predetermined clamping force value again at step 118. If the updated estimated clamping force is greater than or equal to the threshold predetermined clamping force value, then the method proceeds to step 120. If, however, the updated estimated clamping force value is still below the predetermined threshold clamping force value, then the method proceeds back to sub step 116C where an updated motor load torque Tₘ is determined. The method repeats itself in this manner until the estimated clamping force is greater than or equal to the threshold predetermined clamping force value.

The estimated position \hat{θ} determined at sub step 116A is also used to estimate the brake motor current draw Î (i-hat) at sub step 116D and to estimate the brake motor speed \hat{θ} at sub step 116E.

Estimated brake motor current draw Î (i-hat) is estimated or determined at step 116D using the following equation:

Î[k+1]=Ad₂₁*\hat{\dot{θ}}[k]+Ad₂₂*Î[k]+Bd₂*V[k]+Bd₂₂*\hat{τ}\hat{θ}[k]+L_{c}{I[k]−Î[k]}

Estimated brake motor speed \hat{\dot{θ}} is the speed at which the output of the brake motor rotates or moves. As the clamping force increases, the brake motor speed \hat{\dot{θ}} decreases. The estimated brake motor speed \hat{\dot{θ}} is estimated or determined using the following equation:

\hat{\dot{θ}}[k+1]Ad₁₁*\hat{\dot{θ}}[k]+Ad₁₂*Î[k]+Bd₁₁*V[k]+Bd₁₂*\hat{τ}\hat{θ}[k]+Lₛ{I[k]−Î[k])}

The estimated brake motor current draw Î (i-hat) from sub step 116D and the estimated brake motor speed \hat{\dot{θ}} from sub step 116E and then fed back into step 116A where the updated estimated position \hat{θ} is determined. The estimated brake motor speed \hat{\dot{θ}} and the estimated brake motor current draw Î (i-hat) are continuously fed back into sub step 116A in a loop until the estimated clamping force at step 116B is greater than or equal to the predetermined threshold clamping force value and the method goes to step 120 where the method is complete.

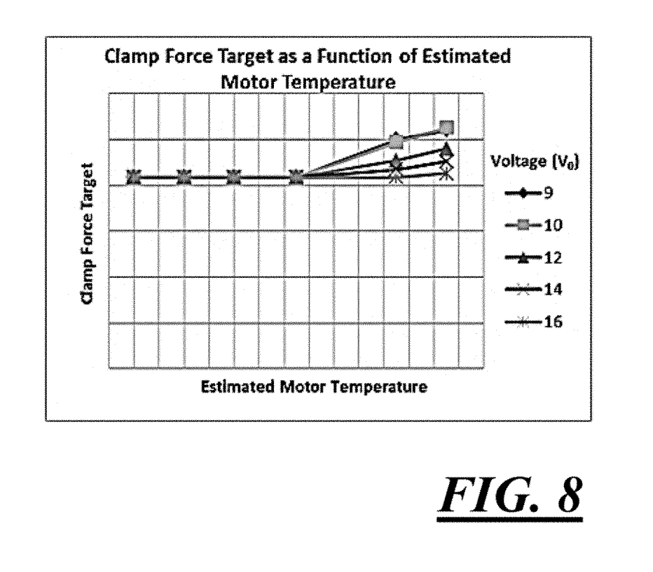

Referring to FIG. 8, the predetermined threshold clamping force value, which may also be referred to as clamp force target, may shift or change or update depending on the estimated motor temperature, which was estimated or determined at or during step 110.

That is, the voltage is continuously monitored and stored in memory. As the estimated temperature of the motor from step 110 increases (i.e., see FIG. 5) and the voltage increases, the clamp force target changes. Thus, the clamp force target value that is used in step 118 will shift or change as the estimated motor temperature and voltage increases.

1) A method of controlling a brake, comprising steps of:
determining a motor time constant,
estimating a motor temperature of a motor based on the motor time constant,
estimating a position of component of the brake,
estimating a clamping force based on the estimated position of the component,
comparing the estimated clamping force to a threshold predetermined clamping force value to determine if a sufficient clamping force has been created.

2) The method according to claim 1, wherein the method includes a step of: measuring an inrush current.

3) The method according to claim 1, wherein the method includes a step of: measuring a free running current and a free running voltage.

4) The method according to claim 2, wherein the method includes a step of: measuring a free running current and a free running voltage after the inrush current is measured.

5) The method according to claim 4, wherein the step of measuring the free running current and the free running voltage is during a no-load condition.

6) The method according to claim 3, wherein the motor time constant is determined using a formula that includes (Iₚₑₐₖ−I₀)*(1−1/exp(1))+I0), where Iₚₑₐₖ is an inrush current and I₀ is the free running current.

7) The method according to claim 2, wherein the motor time constant is determined when current supplied to the motor is at or about 36.8% of the measured inrush current.

8) The method according to claim 1, wherein the method includes steps of: determining motor resistance, determining motor torque constant, and determining viscosity.

9) The method according to claim 1, wherein the method includes steps of: determining motor resistance, determining motor torque constant, and determining viscosity based on the estimated motor temperature, and
wherein:
a) the motor resistance is calculated using a formula: Rₐ=Rₐ0*[1+α*(T_{c}−25)]; and
b) the motor torque constant is calculated using a formula of Kₜ=Kₜ₀*[(1+β*(T_{c}−25)].

10) The method according to claim 7, wherein the method includes steps of: determining motor resistance, determining motor torque constant, and determining viscosity based on the motor time constant, and
wherein:
a) the motor resistance is calculated using a formula: Rₐ=Rₐ0*[1+α*(T_{c}−25)]; and
b) the motor torque constant is calculated using a formula of Kₜ=Kt0*[(1+β*(T_{c}−25)].

11) The method according to claim 1, wherein the method includes a step of: determining a knee point, and
wherein the knee point is a zero-clearance condition between a braking component of the brake and a moving component of the brake.

12) The method according to claim 11, wherein the knee point is determined when a change in current supplied to a brake motor divided by a change in an angular position of a brake motor is greater than, or equal to, a threshold, predetermined value.

13) The method according to claim 1, wherein the method includes a step of: updating the threshold predetermined clamping force value depending on the estimated motor temperature.

14) The method according to claim 1, wherein the method includes a step of: updating the threshold predetermined clamping force value depending on the estimated motor temperature and a change in voltage.

15) The method according to claim 1, wherein the method includes a step of: determining a motor load torque.

16) The method according to claim 1, wherein the method includes a step of estimating a brake motor speed of a brake motor.

17) The method according to claim 16, wherein the method includes a step of: estimating current draw by the brake motor.

18) The method according to claim 17, wherein the estimated brake motor speed and the estimated current draw are used to update the estimated position of the component of the brake.

19) The method according to claim 1, wherein the brake is a service brake.

20) The method according to claim 1, wherein the brake is a parking brake.
